(19) United States
(12) Patent Application Publication
(10) Pub. No.: US 2023/0393784 A1
(43) Pub. Date: Dec. 7, 2023

(54) DATA PATH SEQUENCING IN MEMORY SYSTEMS

(71) Applicant: Micron Technology, Inc., Boise, ID (US)

(72) Inventor: Rohitkumar Makhija, Milpitas, CA (US)

(21) Appl. No.: 17/832,068

(22) Filed: Jun. 3, 2022

(51) Int. Cl. G06F 3/06

(52) U.S. Cl. CPC G06F 3/0659; G06F 3/0604; G06F 3/0679

(57) ABSTRACT

Described are systems and methods for data path scheduling in memory systems. An example system comprises: a memory array comprising a plurality of memory cells; and a controller coupled to the memory array, the controller to perform operations comprising: retrieving a memory access command from a memory access command queue; identifying a memory device specified by the memory access command; verifying availability of the memory device; verifying availability of one or more resources that are required for servicing the memory access command; transmitting the memory access command to the memory device; and removing the memory access command from the memory access command queue.

### TECHNICAL FIELD

Embodiments of the disclosure relate generally to memory sub-systems, and more specifically, to implementing a data path sequencer in memory devices.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 is a block diagram of a memory device in communication with a memory sub-system controller of a memory sub-system, according to an embodiment.

FIG. 3A schematically illustrates a set of memory cells as arranged in a memory device.

FIG. 3B schematically illustrates schematically dependence of the source-drain current on the control gate voltage for two memory cells.

FIG. 3C schematically illustrates an example distribution of threshold control gate voltages for a memory cell.

FIG. 4 schematically illustrates a high-level component diagram of a memory sub-system controller implemented in accordance with one or more aspects of the present disclosure.

FIG. 5 is a flow diagram of an example scheduling method 500 that can be implemented by a memory controller operating in accordance with aspects of the present disclosure.

FIG. 6 is a flow diagram of an example method of traversing multiple memory access command queues that can be implemented by a memory controller operating in accordance with aspects of the present disclosure.

FIG. 7 is a block diagram of an example computer system in which embodiments of the present disclosure can operate.

### DETAILED DESCRIPTION

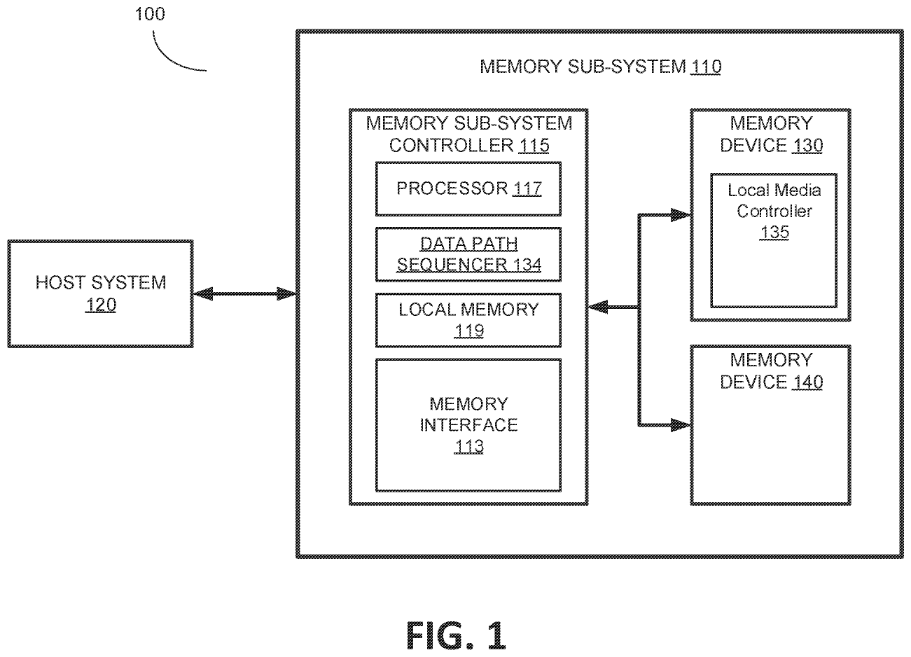

Aspects of the present disclosure are directed implementing a data path sequencer in memory systems. A memory sub-system can include one or more storage devices, memory modules, or a combination of storage devices and memory modules. Examples of storage devices and memory modules are described below in conjunction with FIG. 1. In general, a host system can utilize a memory sub-system that includes one or more memory components, such as memory devices that store data. The host system can provide data to be stored at the memory sub-system and can request data to be retrieved from the memory sub-system.

A memory sub-system can utilize one or more memory devices, including any combination of the different types of non-volatile memory devices and/or volatile memory devices, to store the data provided by the host system. In some embodiments, non-volatile memory devices can be provided by negative-and (NAND) type flash memory devices. Other examples of non-volatile memory devices are described below in conjunction with FIG. 1. A non-volatile memory device is a package of one or more dice. Each die can include one or more planes. A plane is a portion of a memory device that includes multiple memory cells. Some memory devices can include two or more planes. For some types of non-volatile memory devices (e.g., NAND devices), each plane includes a set of physical blocks. Each block includes a set of pages. “Block” herein shall refer to a set of contiguous or non-contiguous memory pages. A “block” may refer to a unit of the memory device used to store data and can include a group of memory cells. An example of a “block” is an “erasable block,” which is the minimal erasable unit of memory, while “page” is a minimal writable unit of memory. Each page includes a set of memory cells. A memory cell is an electronic circuit that stores information.

A memory device can include multiple memory cells arranged in a two-dimensional grid. The memory cells are formed onto a silicon wafer in an array of columns and rows. A memory cell includes a capacitor that holds an electric charge and a transistor that acts as a switch controlling access to the capacitor. Accordingly, the memory cell may be programmed (written to) by applying a certain voltage, which results in an electric charge being held by the capacitor. The memory cells are joined by wordlines, which are conducting lines electrically connected to the control gates of the memory cells, and bitlines, which are conducting lines electrically connected to the drain electrodes of the memory cells.

One or more blocks can be grouped together to form a plane of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types.

Data operations can be performed by the memory sub-system. The data operations can be host-initiated operations. For example, the host system can initiate a data operation (e.g., write, read, erase, etc.) on a memory sub-system. The host system can send access requests (e.g., write command, read command, programming command, etc.) to the memory sub-system, such as to store data on a memory device at the memory sub-system and to read data from the memory device on the memory sub-system.

Depending on the cell type, each memory cell can store one or more bits of binary information, and has various logic states that correlate to the number of bits being stored. The logic states can be represented by binary values, such as “0” and “1”, or combinations of such values. A memory cell can be programmed (written to) by applying a certain voltage to the memory cell, which results in an electric charge being held by the memory cell, thus allowing modulation of the voltage distributions produced by the memory cell. A set of memory cells referred to as a memory page can be programmed together in a single operation, e.g., by selecting consecutive bitlines.

Precisely controlling the amount of the electric charge stored by the memory cell allows establishing multiple logical levels, thus effectively allowing a single memory cell to store multiple bits of information. A read operation can be performed by comparing the measured threshold voltages (Vt) exhibited by the memory cell to one or more reference voltage levels in order to distinguish between two logical levels for single-level cells (SLCs) and between multiple logical levels for multi-level cells. In various embodiments, a memory device can include multiple portions, including, e.g., one or more portions where the sub-blocks are configured as SLC memory and one or more portions where the sub-blocks are configured as multi-level cell (MLC) memory that can store three bits of information per cell and/or (triple-level cell) TLC memory that can store three bits of information per cell. The voltage levels of the memory cells in TLC memory form a set of 8 programming distributions representing the 8 different combinations of the three bits stored in each memory cell. Depending on how they are configured, each physical page in one of the sub-blocks can include multiple page types. For example, a physical page formed from single level cells (SLCs) has a single page type referred to as a lower logical page (LP). Multi-level cell (MLC) physical page types can include LPs and upper logical pages (UPs), TLC physical page types are LPs, UPs, and extra logical pages (XPs), and quad level cells (QLC) physical page types are LPs, UPs, XPs and top logical pages (TPs). For example, a physical page formed from memory cells of the QLC memory type can have a total of four logical pages, where each logical page can store data distinct from the data stored in the other logical pages associated with that physical page.

Memory access operations (e.g., a programming (write) operation, an erase operation, etc.) can be executed with respect to the memory cells by sequentially applying programming voltage pulses to selected wordlines, which are connected to the target memory cells. In some implementations, the programming pulse voltage can be sequentially ramped up from the initial voltage value (e.g., 0V) to the final voltage value (e.g., V_{PGM MAX}).

In order to satisfy various performance, timing, and other specifications, the memory sub-system controller (“controller”) can implement a scheduling algorithm for processing memory access commands based on their assigned priorities. In some implementations, the scheduling and ordering of memory access commands may be implemented by the controller using one or more memory access command queues, which can reside in the internal memory of the controller. Accordingly, upon receiving a memory access command via the host interface, the controller may place it into an appropriate queue. In some implementations, each queue is associated (e.g., by a metadata value that can be stored in the internal memory of the controller in associated with the queue) with a respective priority level.

The memory access commands can be retrieved from the queue by a dedicated functional component of the controller, which is referred to herein as “data path sequencer.” The data path sequencer can be a general purpose or a specialized processing device (e.g., a CPU or an ASIC), which can implement a set of functions for servicing the memory access command queues. The parameters and/or executable instructions of the scheduling algorithms implemented by the data path sequencer may be stored in the internal storage of the controller. Storing the scheduling parameters and executable instructions in memory allows post-manufacturing reprogramming of the data path sequencer, thus providing greater flexibility in satisfying various performance and timing specifications, which in turn allows utilizing the controller in various applications ranging from mobile to enterprise applications, as well as utilizing the controller with future generations of memory devices, which might not yet be available or even designed at the time of manufacturing the controller.

The data path sequencer can traverse the memory access command queues in the order of their priorities starting with the highest priority queue. In each queue, the data path sequencer can process the memory access commands starting from the head of the queue. Processing each memory access command involves performing a sequence of validation operations with respect to the memory access command. The validation operations may involve verifying availability of the memory device, verifying availability of one or more hardware resources, validating the power requirements of the memory access command, etc. Responsive to successfully completing all the requisite validation operations, the data path sequencer executes the memory access command by forwarding it to the appropriate memory device and removes the memory access command from the queue, as described in more detail herein below.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) and a hard disk drive (HDD). Examples of memory modules include a dual in-line memory module (DIMM), a small outline DIMMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130,140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (“controller”) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can be a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which includes a raw memory device 130 having control logic (e.g., local media controller 135) on the die and a controller (e.g., memory sub-system controller 115) for media management within the same memory device package. An example of a managed memory device is a managed NAND (MNAND) device.

In one embodiment, the memory sub-system 110 includes a memory interface component 113. Memory interface component 113 is responsible for handling interactions of memory sub-system controller 115 with the memory devices of memory sub-system 110, such as memory device 130. For example, memory interface component 113 can send memory access commands corresponding to requests received from host system 120 to memory device 130, such as program commands, read commands, or other commands. In addition, memory interface component 113 can receive data from memory device 130, such as data retrieved in response to a read command or a confirmation that a program command was successfully performed. For example, the memory sub-system controller 115 can include a processor 117 (processing device) configured to execute instructions stored in local memory 119 for performing the operations described herein.

In one embodiment, the memory sub-system controller 115 includes a data path sequencer 134 configured to perform scheduling of memory access operations which the memory sub-system controller receives from memory interface 113. In some embodiments, at least part of the functionality of the data path sequencer 134 can be performed by the local media controller 135. In some embodiments, data path sequencer 134 is implemented by firmware, hardware components, or a combination of the above.

The data path sequencer 134 can implement a set of functions for servicing the memory access command queues. In particular, the data path sequencer 134 can process the memory access command queues in the order of their priorities starting with the highest priority queue. Processing each memory access command queue involves performing a sequence of validation operations with respect to the memory access command. The validation operations may involve verifying availability of the memory device 130, verifying availability of one or more hardware resources, validating the power requirements of the memory access command, etc. Responsive to successfully completing all the requisite validation operations, the data path sequencer executes the memory access command by forwarding it to the appropriate memory device 130 and removes the memory access command from the queue, as described in more detail herein below.

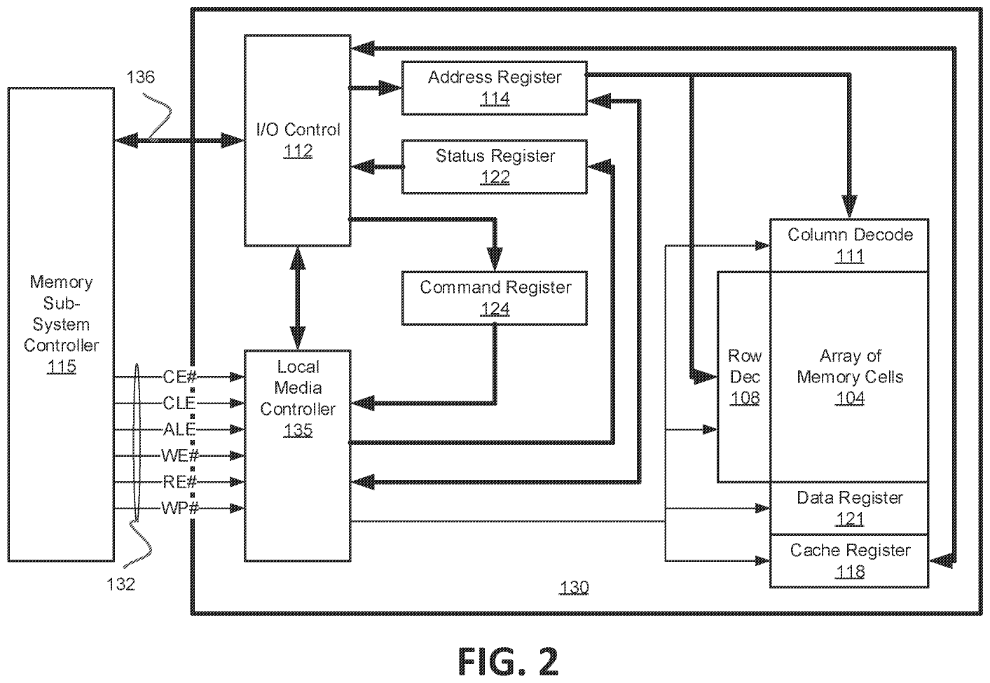

FIG. 2 is a simplified block diagram of a first apparatus, in the form of a memory device 130, in communication with a second apparatus, in the form of a memory sub-system controller 115 of a memory sub-system (e.g., memory sub-system 110 of FIG. 1), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bitline). A single access line may be associated with more than one logical row of memory cells and a single data line may be associated with more than one logical column. Memory cells (not shown in FIG. 2) of at least a portion of array of memory cells 104 are capable of being programmed to one of at least two target data states.

Row decode circuitry 108 and column decode circuitry 111 are provided to decode address signals. Address signals are received and decoded to access the array of memory cells 204. Memory device 130 also includes input/output (I/O) control circuitry 112 to manage input of commands, addresses and data to the memory device 130 as well as output of data and status information from the memory device 130. An address register 114 is in communication with I/O control circuitry 112 and row decode circuitry 108 and column decode circuitry 111 to latch the address signals prior to decoding. A command register 124 is in communication with I/O control circuitry 112 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 204. The local media controller 135 is in communication with row decode circuitry 108 and column decode circuitry 111 to control the row decode circuitry 108 and column decode circuitry 111 in response to the addresses.

The local media controller 135 is also in communication with a cache register 218. Cache register 118 latches data, either incoming or outgoing, as directed by the local media controller 135 to temporarily store data while the array of memory cells 104 is busy writing or reading, respectively, other data. During a programming operation (e.g., a write operation), data may be passed from the cache register 118 to the data register 121 for transfer to the array of memory cells 204; then new data may be latched in the cache register 118 from the I/O control circuitry 212. During a read operation, data may be passed from the cache register 118 to the I/0 control circuitry 112 for output to the memory sub-system controller 115; then new data may be passed from the data register 121 to the cache register 218. The cache register 118 and/or the data register 121 may form (e.g., may form a portion of) a page buffer of the memory device 130. A page buffer may further include sensing devices (not shown in FIG. 2) to sense a data state of a memory cell of the array of memory cells 204, e.g., by sensing a state of a data line connected to that memory cell. A status register 122 may be in communication with I/O control circuitry 112 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 136 and outputs data to the memory sub-system controller 115 over I/O bus 136.

For example, the commands may be received over input/output (I/O) pins [7:0] of I/O bus 136 at I/O control circuitry 112 and may then be written into command register 224. The addresses may be received over input/output (I/O) pins [7:0] of I/O bus 136 at I/O control circuitry 112 and may then be written into address register 214. The data may be received over input/output (I/O) pins [7:0] for an 8-bit device or input/output (I/O) pins [15:0] for a 16-bit device at I/O control circuitry 112 and then may be written into cache register 218. The data may be subsequently written into data register 121 for programming the array of memory cells 204.

In an embodiment, cache register 118 may be omitted, and the data may be written directly into data register 220. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

In some implementations, additional circuitry and signals can be provided, and the memory device 130 of FIG. 2 has been simplified. It should be recognized that the functionality of the various block components described with reference to FIG. 2 may not necessarily be segregated to distinct components or component portions of an integrated circuit device. For example, a single component or component portion of an integrated circuit device could be adapted to perform the functionality of more than one block component of FIG. 2. Alternatively, one or more components or component portions of an integrated circuit device could be combined to perform the functionality of a single block component of FIG. 2. Additionally, while specific I/O pins are described in accordance with popular conventions for receipt and output of the various signals, it is noted that other combinations or numbers of I/O pins (or other I/O node structures) may be used in the various embodiments.

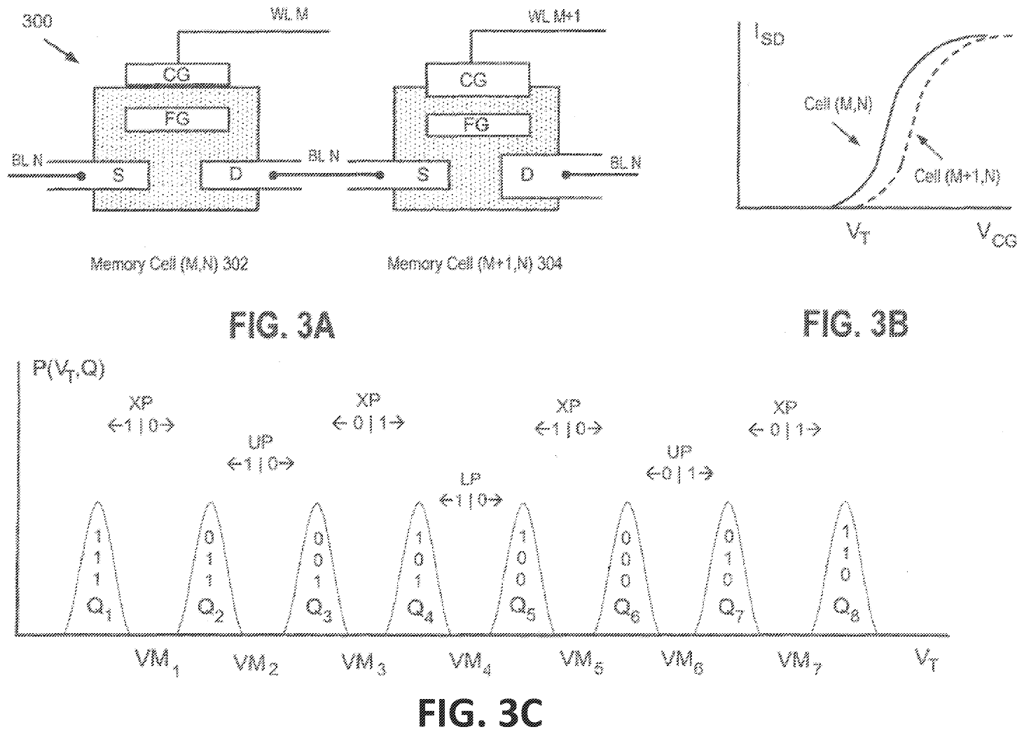

One or more memory devices of the memory sub-system 100 can be represented, e.g., by NAND memory devices that utilize transistor arrays built on semiconductor chips. As illustrated schematically in FIG. 3A, a memory cell of a memory device can be a transistor, such as a metal-oxide-semiconductor field effect transistor (MOSFET), having a source (S) electrode and a drain (D) electrode to pass electric current there through. The source and drain electrodes can be connected to a conductive bitline (BL), which can be shared by multiple memory cells. A memory device can include an array or memory cells that are connected to a plurality of wordlines (WL) and a plurality of bitlines (BL). A memory device can further include circuitry for selectively coupling WLs and BLs to voltage sources providing control gate and source-drain signals.

Referring again to FIG. 3A, memory cells 302 and 304 can be connected to the same bitline N and two different conductive wordlines, M and M+1, respectively. A memory cell can further have a control gate (CG) electrode to receive a voltage signal V_{CG} to control the magnitude of electric current flowing between the source electrode and the drain electrode. More specifically, there can be a threshold control gate voltage V_{T} (herein also referred to as “threshold voltage” or simply as “threshold”) such that for V_{CG}<V_{T}, the source-drain electric current can be low, but can increase substantially once the control gate voltage has exceeded the threshold voltage, V_{CG}>V_{T}. Transistors of the same memory device can be characterized by a distribution of their threshold voltages, P(V_{T})=dW/dV_{T}, so that dW=P(V_{T})dV_{T} represents the probability that any given transistor has its threshold voltage within the interval [V_{T},V_{T}+dV_{T}]. For example, FIG. 3B illustrates schematically dependence of the source-drain current I_{SD} on the control gate voltage for two memory cells, e.g. memory cell 302 (solid line) and memory cell 304 (dashed line), having different threshold control gate voltages.

To make a memory cell non-volatile, the cell can be further equipped with a conducting island—a charge storage node—that can be electrically isolated from the control gate, the source electrode, and the drain electrode by insulating layers (depicted in FIG. 3A as the dotted region). In response to an appropriately chosen positive (in relation to the source potential) control gate voltage V_{CG}, the charge storage node can receive an electric charge Q, which can be permanently stored thereon even after the power to the memory cell—and, consequently, the source-drain current—is ceased. The charge Q can affect the distribution of threshold voltages P(V_{T},Q). Generally, the presence of the electric charge Q shifts the distribution of threshold voltages towards higher voltages, compared with the distribution P(V_{T}) for an uncharged charge storage node. This happens because a stronger positive control gate voltage V_{CG} can be needed to overcome a negative potential of the charge storage node charge Q. If any charge of a sequence Qₖ of charges with 1≤k≤2^{N} can be selectively programmed (and later detected during a read operation) into a memory cell, the memory cell can function as an N-bit storage unit. The charges Qₖ are preferably selected to be sufficiently different from each other, so that any two adjacent voltage distributions P(V_{T}, Qₖ) and P(V_{T}, Qₖ₊₁) do not overlap being separated by a valley margin, so that 2^{N} distributions P(V_{T}, Qₖ) are interspaced with 2^{N}−1 valley margins.

Memory devices can be classified by the number of bits stored by each cell of the memory. For example, a single-level cell (SLC) memory has cells that can each store one bit of data (N=1). A multi-level cell (MLC) memory has cells that can each store up to two bits of data (N=2), a tri-level cell (TLC) memory has cells that can each store up to three bits of data (N=3), and a quad-level cell (QLC) memory has cells that can each store up to four bits of data (N=4). For example, a TLC can be capable of being in one of eight charging states Qₖ (where the first state is an uncharged state Q₁=0) whose threshold voltage distributions are separated by valley margins VMₖ that can be used to read out the data stored in the memory cells.

FIG. 3C illustrates schematically a distribution of threshold control gate voltages for a memory cell capable of storing three bits of data by programming the memory cell into at least eight charge states (also referred to as “programming levels”) that differ by the amount of charge on the cell's charge storage node. FIG. 3C shows distributions of threshold voltages P(V_{T}, Qₖ) for 2^{N}=8 different charge states of a tri-level cell (TLC) separated with 2³−1=7 valley margins VMₖ. Accordingly, a memory cell programmed into a charge state k-th (i.e., having the charge Qₖ deposited on its charge storage node) can be storing a particular combination of N bits (e.g., 0110, for N=4). This charge state Qₖ can be determined during a readout operation by detecting that a control gate voltage V_{CG} within the valley margin VMₖ is sufficient to open the cell to the source-drain current whereas a control gate voltage within the preceding valley margin VMₖ₋₁ is not.

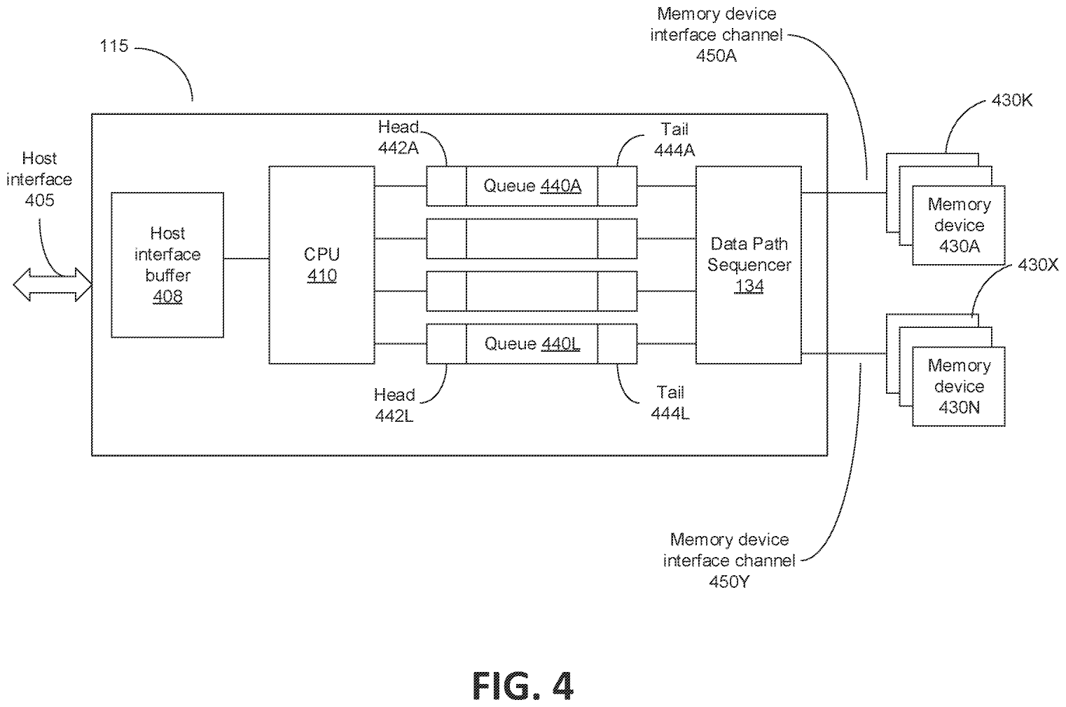

FIG. 4 schematically illustrates a high-level component diagram of a controller (e.g., a memory sub-system controller 115 of FIG. 1) implemented in accordance with one or more aspects of the present disclosure. FIG. 4 is limited to only illustrating certain components of the controller 115. Various functional and/or auxiliary circuitry which is omitted from FIG. 4 for clarity and conciseness.

As schematically illustrated by FIG. 4, the controller 115 includes a central processing unit (CPU) 410. While in the illustrative example of FIG. 4 shown is a single CPU 410, in various other implementations two or more CPUs 410 can be employed, which can be collectively referred to as “processing device.”

The controller 115 is connected to the host (not shown in FIG. 4) via the host interface 405, which can transmit control, address, data, and other signals between the host and the controller 115. In an illustrative example, the host interface 405 is represented by the Peripheral Component Interconnect express (PCIe) interface, and NVM Express (NVMe) protocol can be implemented over the host interface. The controller 115 is further connected to one or more memory devices 440A-440X via one or more memory interface channels 440A-440Y, which can carry memory access commands and data. In an illustrative example, the memory interface is represented by Open NAND Flash Interface (ONFI) interface. In various implementations, one or more memory devices 330 can be connected to each memory interface channel 340. The memory device interface bus can be managed by the data path sequencer 134.

As noted herein above, the memory access commands carried over the memory interface can include, e.g., read, write (program), erase, and/or memory device configuration commands. In order to satisfy various performance, timing, and other specifications, the controller 115 can implement one or more priority schemes for processing the memory access commands. In some implementations, a scheduling algorithm can be implemented for processing memory access commands based on their assigned priorities (e.g., the time slices allocated to processing memory access commands may be determined based on the priority levels of memory access command types). In an illustrative example, all types of memory access commands can be assigned the same priority level, such that all commands will be processed in the order they were received. Alternatively, some types of memory access commands can be assigned a higher priority level than other types of memory access commands, such that higher priority commands will be processed before lower priority commands.

In some implementations, the scheduling and ordering of memory access commands may be implemented by the central processing unit 410 using one or more memory access command queues 440A-440L, each of which is represented by a memory buffer that stores a sequence of memory access commands. Accordingly, upon receiving a memory access command via the host interface 405, the CPU 410 may place it into an appropriate queue 440A-440L. In some implementations, the queues are differentiated by their respective priorities, such as queue 440A is associated with the highest priority level, queue 440L is associated with the highest priority level, and the remaining queues are associated with intermediate priority levels P₁>P₂>P₄>>P_{L}.

Each queue 440 can have the head 442 and the tail 444, such that the memory access commands are placed to the tail of the queue by the CPU 410 and are retrieved from the head of the queue by the data path sequencer 134. Upon placing a new command to the tail, the tail pointer is incremented accordingly. Upon removing a command from the head, the head pointer is incremented accordingly. In various implementations, the memory access command queues 440 can be implemented by ring buffers, linear buffers, linked lists, or other suitable data structures.

The data path sequencer 134 can forward the retrieved memory access commands, via the memory interface channels 450A-450Y, to the memory devices 430A-430N. In some implementations, the data path sequencer 134 can be implemented by a general purpose or a specialized processing device (e.g., a CPU or an ASIC), which can perform a set of functions for servicing the memory access command queues 440A-440L. In some implementations, at least some functionality of the data path sequencer 134 can be performed by the CPU 410. The parameters and/or executable instructions of the scheduling algorithms implemented by the data path sequencer 134 may be stored in the internal memory of the data path sequencer 134 and/or in one or more internal memory devices of the memory controller 115. Storing the scheduling parameters and executable instructions in memory allows post-manufacturing reprogramming of the data path sequencer 134, thus providing greater flexibility in satisfying various performance and timing specifications.

The data path sequencer 134 processes the memory access command queues 440A-440L in the order of their priorities starting with the highest priority queue. Upon processing the last entry in the current queue, the data path sequencer 134 starts processing the next queue in the order of queue priorities. Upon processing the lowest priority queue, the data path sequencer 134 starts processing the higher priority queue. This process is repeated indefinitely, while the memory sub-system is powered.

Processing each memory access command queue 440 involves retrieving the head entry from the current queue and performing a sequence of validation operations with respect to the memory access command contained by the head entry of the memory access queue. The validation operations may involve verifying availability of the memory device, verifying availability of one or more hardware resources, validating the power requirements of the memory access command, etc. Responsive to successfully completing all the requisite validation operations, the data path sequencer 134 executes the memory access command by forwarding it to the appropriate memory device 430A-430N via the memory device interface 450 and removes the memory access command from the queue.

Conversely, should the data path sequencer 134 fail to successfully complete at least one validation operation with respect to the memory access command, the memory access command is left in the queue, and the data path sequencer 134 retrieves the next entry from the queue. While the data path sequencer 134 is traversing each queue from its head to its tail, the CPU 410 can submit new memory access commands to the queue by appending them after the tail entry of the queue.

In some implementations, several processing threads can be supported for every memory access command queue 440, such that each processing thread would process memory access commands directed to a corresponding memory device 340A-430N. Thus, with respect to a given memory device 340L, the memory access commands are executed in order from a given queue, but across different memory devices 340L out of order execution is possible. For example, if a certain memory access command for a given memory device 340L is not executed, then the next memory access command to the same memory device 340L would not be executed either, while a subsequent command directed to a different memory device 340P can be executed out of order. Alternatively, a separate memory access command queue can be implemented for each memory device 340.

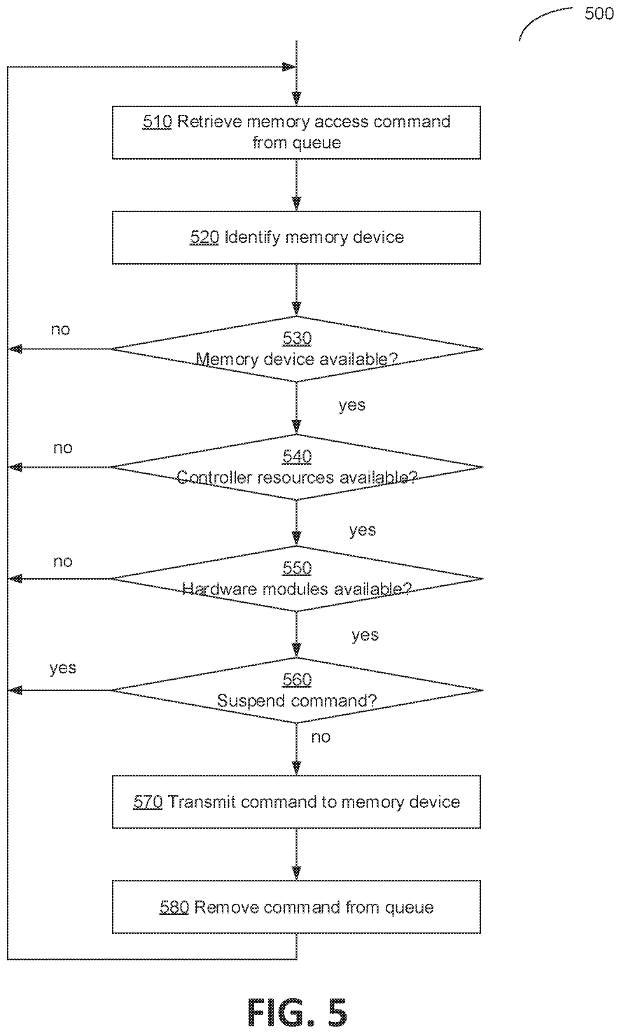

FIG. 5 is a flow diagram of an example scheduling method 500 that can be implemented by a memory controller operating in accordance with aspects of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the memory sub-system controller 115 and/or the local media controller 135 of FIG. 1. Operations of the method 500 may be specified by a sequence of command codes, which the processing device can retrieve from a dedicated storage location. Although shown in a particular sequence or order, unless otherwise specified, the order of the operations can be modified. Thus, the illustrated embodiments should be understood only as examples, and the illustrated operations can be performed in a different order, and some operations can be performed in parallel. Additionally, one or more operations can be omitted in various embodiments. Thus, not all operations are required in every embodiment.

At operation 510, the controller implementing the method retrieves a memory access command from the head of the memory access command queue that is currently being processed. The memory access command can be, e.g., a read command, a write command, an erase command, or a memory device configuration command. The controller can maintain multiple memory access command queues, each of which is represented by a memory buffer that stores a sequence of memory access commands. The queues can be processed by the data path sequencer in the order of their priorities starting with the highest priority queue, as explained in more detail herein above.

At operation 520, the controller identifies the memory device specified by the memory access command. In an illustrative example, the controller can translate the logical address specified by the memory access command to a corresponding physical address, which can include an identifier of the memory device.

At operation 530, the controller implementing the method verifies the availability status of the memory device to which the memory access command is directed. If the memory device is available, the controller can perform the next validation operation (e.g., operation 540). Conversely, if the memory device is busy, the validation operation fails, which can result in holding one or more memory access commands directed to this memory device, including the memory access command that is currently being processed, in the memory access command queue. If the validation operation fails, the head pointer of the current queue is incremented without removing the current command from the queue, and the method loops back to operation 510. Furthermore, in some busy states, the controller performs data transfer on the memory device interface channel or checks the status of the memory device (not shown in FIG. 5).

At operation 540, the controller verifies availability of the controller resources that are required for servicing the memory access command. Such resources may include power, storage (e.g., internal memory buffer(s) residing within the internal memory of the controller), memory device interface channels, etc. In an illustrative example, the memory access operation may only be allowed to proceed if it fits a predefined power budget, which may specify the amount of power to be spent within a certain time or for processing a certain amount of memory access traffic. In another illustrative example, the memory access operation, based on its type (e.g., a read operation) may require an internal memory buffer for temporarily storing the data retrieved from the memory device. If all the requisite resources are available, the controller can perform the next validation operation (e.g., operation 550). Conversely, if at least one of the requisite controller resources is not available, the validation operation fails, which can result in holding one or more memory access commands directed to this memory device, including the memory access command that is currently being processed, in the memory access command queue. If the validation operation fails, the head pointer of the current queue is incremented without removing the current command from the queue, and the method loops back to operation 510.

At operation 550, the controller verifies availability of one or more hardware modules (e.g., error correction modules) that are required for servicing the memory access command. If all the requisite resources are available, the controller can perform the next validation operation (e.g., operation 560). Conversely, if at least one of the requisite hardware resources is not available, the validation operation fails, which can result in holding one or more memory access commands directed to this memory device, including the memory access command that is currently being processed, in the memory access command queue. If the validation operation fails, the head pointer of the current queue is incremented without removing the current command from the queue, and the method loops back to operation 510.

At operation 560, the controller verifies whether a programming or erase operation needs to be suspended in order for a read operation to proceed. For the suspended memory access operation, the full evaluation method will need to be performed when the operation is resumed. If the validation operation fails, the head pointer of the current queue is incremented without removing the current command from the queue, and the method loops back to operation 510

At operation 570, upon successfully completing all validation operations, the controller executes the memory access command by transmitting it to the appropriate memory device via the memory device interface, as described in more detail herein above.

At operation 580, the controller removes the memory access command from the memory access command queue and increments the head pointer accordingly. Responsive to completing the operation 580, the method loops back to operation 510.

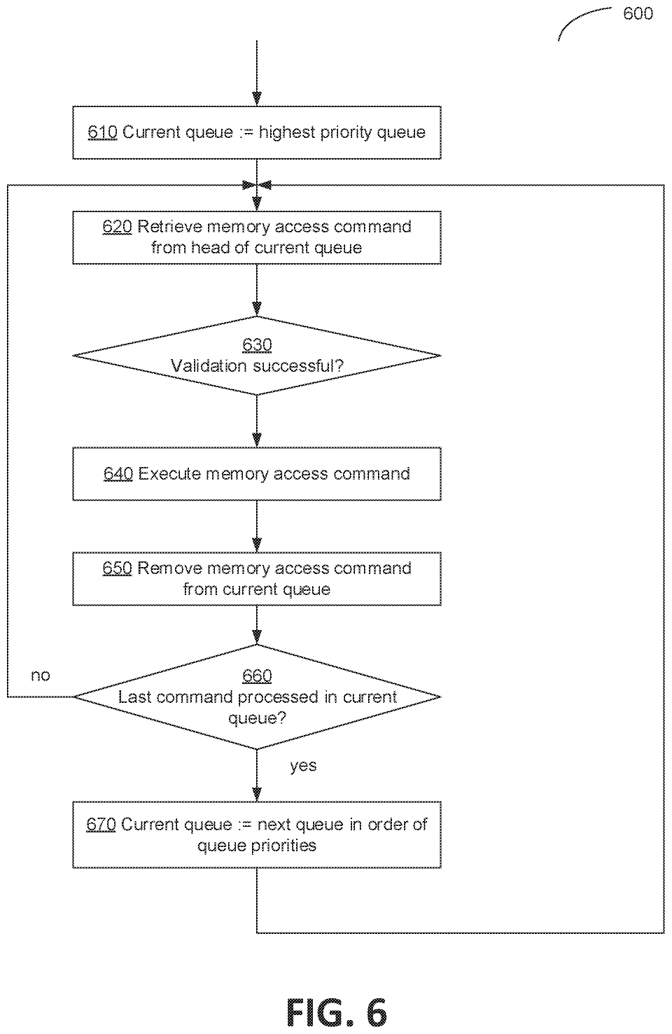

FIG. 6 is a flow diagram of an example method 600 of traversing multiple memory access command queues that can be implemented by a memory controller operating in accordance with aspects of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the memory sub-system controller 116 and/or the local media controller 136 of FIG. 1. Operations of the method 600 may be specified by a sequence of command codes, which the processing device can retrieve from a dedicated storage location. Although shown in a particular sequence or order, unless otherwise specified, the order of the operations can be modified. Thus, the illustrated embodiments should be understood only as examples, and the illustrated operations can be performed in a different order, and some operations can be performed in parallel. Additionally, one or more operations can be omitted in various embodiments. Thus, not all operations are required in every embodiment.

At operation 610, the controller implementing the method identifies, as the current queue, a memory access command queue associated with the highest priority level, as described in more detail herein above.

At operation 620, the controller retrieves a memory access command from the head of the current memory access command queue. The memory access command can be, e.g., a read command, a write command, an erase command, or a memory device configuration command, as described in more detail herein above.

At operation 630, the controller performs validation operations, e.g., with respect to the availability of the memory device specified by the memory access command, and/or with respect to the availability of controller resources that are required for servicing the memory access command, as described in more detail herein above. If all validations have been completed successfully, the processing continues at operation 640. Otherwise, if at least one of the validation operation fails, the head pointer is incremented without removing the current command from the queue, and the method loops back to operation 620.

At operation 640, upon successfully completing all validation operations, the controller executes the memory access command by transmitting it to the appropriate memory device via the memory device interface, as described in more detail herein above.

At operation 650, the controller removes the memory access command from the memory access command queue and increments the head pointer accordingly.

Responsive to determining, at operation 660, that the current memory access command queue contains no more memory access commands, the controller, at operation, 670, selects the next queue in the order the queue priorities (e.g., a queue having a lower priority with respect to the queue that has just been processed, or the highest priority queue if the lowest priority queue has just been processed), and the method loops back to operation 620.

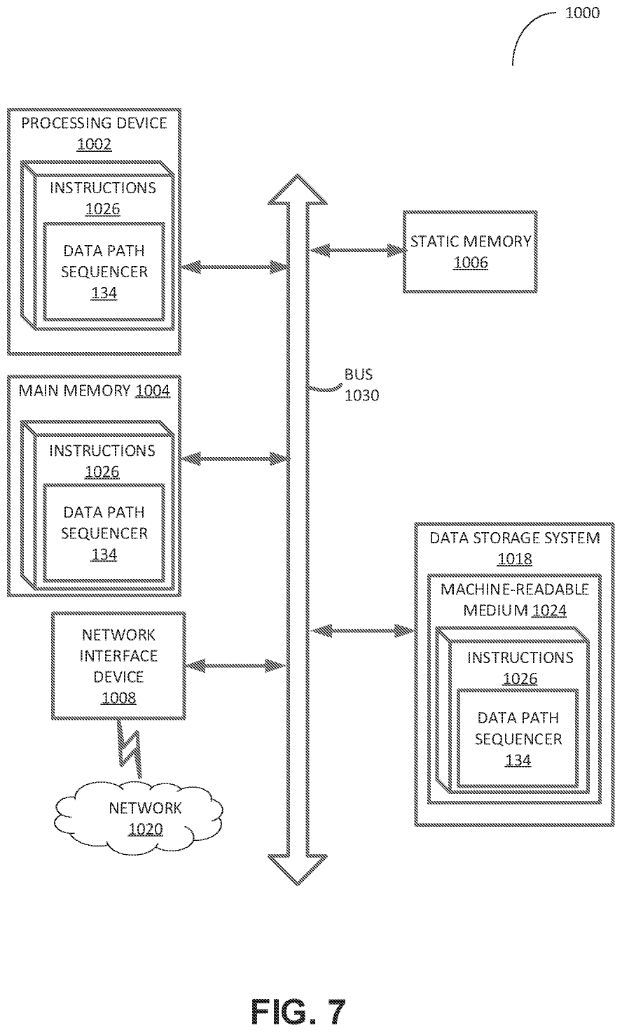

FIG. 7 illustrates an example machine of a computer system 1000 within which a set of instructions, for causing the machine to perform any one or more of the methodologies discussed herein, can be executed. In some embodiments, the computer system 1000 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to programming manager 104 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM) or Rambus DRAM (RDRAM), etc.), a static memory 1006 (e.g., flash memory, static random access memory (SRAM), etc.), and a data storage system 1019, which communicate with each other via a bus 1030.

Processing device 1002 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1002 can also be one or more special-purpose processing devices such as an application specific integrated circuit (ASIC), a field programmable gate array (FPGA), a digital signal processor (DSP), network processor, or the like. The processing device 1002 is configured to execute instructions 1026 for performing the operations and steps discussed herein. The computer system 1000 can further include a network interface device 1009 to communicate over the network 1020.

The data storage system 1019 can include a machine-readable storage medium 1104 (also known as a computer-readable medium, such as a non-transitory computer-readable medium) on which is stored one or more sets of instructions 1026 or software embodying any one or more of the methodologies or functions described herein. The instructions 1026 can also reside, completely or at least partially, within the main memory 1004 and/or within the processing device 1002 during execution thereof by the computer system 1000, the main memory 1004 and the processing device 1002 also constituting machine-readable storage media. The machine-readable storage medium 1024, data storage system 1019, and/or main memory 1004 can correspond to the memory sub-system 110 of FIG. 1.

In one embodiment, the instructions 1026 include instructions to implement functionality corresponding to programming manager 104 of FIG. 1). While the machine-readable storage medium 1024 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system, comprising:
a memory array comprising a plurality of memory cells; and
a controller coupled to the memory array, the controller to perform operations comprising:
retrieving a memory access command from a memory access command queue;
identifying a memory device specified by the memory access command;
verifying availability of the memory device;
verifying availability of one or more resources that are required for servicing the memory access command;
transmitting, in response to verifying availability of the memory device and the one or more resources, the memory access command to the memory device; and
removing the memory access command from the memory access command queue.

2. The system of claim 1, wherein the memory access command is one of: a read command, a write command, an erase command, or a memory device configuration command.

3. The system of claim 1, wherein the operations further comprise:
retrieving, from a predefined storage location, executable instructions specifying a workflow for verifying availability of resources for servicing memory access commands.

4. The system of claim 1, wherein the operations further comprise:
responsive to failing to validate availability of the memory device, leaving the memory access command in the memory access command queue.

5. The system of claim 1, wherein the operations further comprise:
responsive to failing to validate availability of the one or more resources, leaving the memory access command in the memory access command queue.

6. The system of claim 1, wherein the one or more resources comprise an internal memory buffer of a specified size within an internal memory of the controller.

7. The system of claim 1, wherein the one or more resources comprise a specified amount of power for servicing the memory access command.

8. The system of claim 1, wherein the one or more resources comprise an error correction hardware module.

9. The system of claim 1, wherein the operations further comprise:
responsive to determining that a last memory access command has been removed from the memory access command queue, switching to a second memory access command queue having a lower priority than the memory access command queue.

10. The system of claim 1, wherein the operations are performed by a data path sequencer comprised by the controller, and wherein the data path sequencer is implemented by an application specific integrated circuit (ASIC).

11. A computer-readable non-transitory storage medium comprising executable instructions that, when executed by a controller managing a memory array comprising a plurality of memory cells, cause the controller to perform operations, comprising:
retrieving a memory access command from a first memory access command queue of a plurality of memory access command queue, wherein each memory access command queue of the plurality of memory access command queues is associated with a respective priority;
identifying a memory device specified by the memory access command;
transmitting the memory access command to the memory device;
removing the memory access command from the first memory access command queue; and
responsive to determining that a last memory access command has been removed from the first memory access command queue, switching to a second memory access command queue having a lower priority than the memory access command queue.

12. The computer-readable non-transitory storage medium of claim 1, wherein the memory access command is one of: a read command, a write command, an erase command, or a memory device configuration command.

13. The computer-readable non-transitory storage medium of claim 1, wherein the operations further comprise:
retrieving, from a predefined storage location, executable instructions specifying a workflow for verifying availability of resources for servicing memory access commands.

14. The computer-readable non-transitory storage medium of claim 1, wherein the operations are performed by a data path sequencer comprised by the controller, and wherein the data path sequencer is implemented by an application specific integrated circuit (ASIC).

15. A method, comprising:
retrieving, by a processing device, a memory access command from a memory access command queue;
identifying a memory device specified by the memory access command;
verifying availability of the memory device;
verifying availability of one or more resources that are required for servicing the memory access command;
transmitting the memory access command to the memory device; and
removing the memory access command from the memory access command queue.

16. The method of claim 15, wherein the memory access command is one of: a read command, a write command, an erase command, or a memory device configuration command.

17. The method of claim 15, further comprising:
retrieving, from a predefined storage location, executable instructions specifying a workflow for verifying availability of resources for servicing memory access commands.

18. The method of claim 15, further comprising:
responsive to failing to validate availability of the memory device, leaving the memory access command in the memory access command queue.

19. The method of claim 16, further comprising:
responsive to failing to validate availability of the one or more resources, leaving the memory access command in the memory access command queue.

20. The method of claim 16, further comprising:
responsive to determining that a last memory access command has been removed from the memory access command queue, switching to a second memory access command queue having a lower priority than the memory access command queue.
